(19) United States
(12) Patent Application Publication
(10) Pub. No.: US 2024/0257016 A1
(43) Pub. Date: Aug. 1, 2024

(54) System and Method for Predicting Fracture, Reservoir, and Production Characteristics from Hydraulic Fracturing Data.

(71) Applicant: Frac Science Group, LLC, Sugar Land, TX (US)

(72) Inventor: Ashish DABRAL, Katy, TX (US)

(73) Assignee: Frac Science Group, LLC, Sugar Land, TX (US)

(21) Appl. No.: 18/423,687

(22) Filed: Jan. 26, 2024

Related U.S. Application Data
(60) Provisional application No. 63/481,815, filed on Jan. 27, 2023.

(51) Int. Cl. G06Q 10/0637

(52) U.S. Cl. CPC G06Q 10/0637

(57) ABSTRACT

Systems and methods for predicting subterranean formation fracture, reservoir, and/or production characteristics from real time hydraulic fracturing data, historical hydraulic fracturing data or a combination of real time and historical hydraulic fracturing data.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The present inventions relate to predicting subterranean formation fracture, reservoir, and production characteristics from hydraulic fracturing data.

### Description of the Related Art

The production of hydrocarbons from subterranean hydrocarbon-bearing formations is known to be improved by inducing fractures in the formation with high pressure fluid and propping open those fractures with a proppant material, such as sand. The propped open fractures provide additional production channels through which hydrocarbons can enter the well and be brought to the surface.

As with most oilfield processes, however, the devil is in the details. For example, inducing uncontrolled fractures can damage formations and/or link separate formations in undesirable ways. Also, failing to induce sufficient numbers, types, and/or lengths of fractures can restrict the available hydrocarbon production. Still further, placement of the proppant with in the fractures can positively or negatively affect the well's production.

The present inventions provide improved systems and methods for predicting subterranean formation fracture, reservoir, and production characteristics from hydraulic fracturing data.

### BRIEF SUMMARY OF THE INVENTION

A brief non-limiting summary of one of the many possible embodiments of the inventions disclosed herein is a system for predicting fracture, reservoir, and production characteristics from hydraulic fracturing data generated during a fracturing operation of a well, the system comprising: a proppant slurry density meter configured to provide a slurry density signal, the slurry density signal comprising a series of slurry density data points, each data point corresponding to the density of proppant slurry provided to the well during the fracturing operation sensed at a different time; a proppant slurry flow meter configured to provide a slurry flow signal, the slurry flow signal comprising a series of slurry flow data points, each data point corresponding to the flow of proppant slurry provided to the well during the fracturing operation sensed at a different time; a pressure sensor configured to provide a treating pressure signal, the treating pressure signal comprising a series of treating pressure data points, each data point corresponding to a pressure in the he well during the fracturing operation sensed at a different time; a programmable processing system configured to receive the slurry density signal, the slurry flow signal, and the pressure signal, the programmable processing signal being configured to curve fit data points for treating pressure and slurry rate to a linear curve over a plurality of data windows, each data window corresponding to a predetermined period of time; determine the slope of the linear curve for each of the treating pressure and the slurry rate over each data window; identify those widows over which: (1) the treating pressure across the data window is decreasing and (2) the slurry rate across the data window is increasing or constant; and estimate the magnitude of proppant injected into the well for each data window over which the treating pressure is decreasing and the slurry rate is increasing or constant.

Additionally, or alternately, embodiments are envisioned wherein the programmable processing system takes the form of a cloud based system.

These brief summaries of the inventions are not intended to limit or otherwise affect the scope of what has been disclosed and enabled or the scope of the appended claims, and nothing stated in these brief summaries is intended as a definition of a claim term or phrase or as a disavowal or disclaimer of claim scope. These brief summaries are provided for illustrative purposes only and none of the appended claims, ultimately issued claims or claims of any related application or patent are to be limited by these brief summaries or construed to address, include, or exclude each or any of the above-cited features or disadvantages merely because such were mentioned as part of a brief summary of the inventions.

### BRIEF DESCRIPTION OF THE SEVERAL VIEWS OF THE DRAWINGS

The following FIGURES form part of the written disclosure of inventions and are included to demonstrate further certain aspects of the inventions. The inventions may be better understood by reference to one or more of these FIGURES in combination with the detailed description of certain embodiments presented herein.

FIG. 1 illustrates an embodiment of my inventions receiving sensor data streams from a fracking process on a shale formation that has natural fractures.

While the inventions disclosed herein are susceptible to various modifications and alternative forms, only a few specific embodiments have been shown by way of example in the drawings and are described in more detail below. The figures and detailed descriptions of these embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts illustrated and taught by the specific embodiments.

### DETAILED DESCRIPTION

The FIGURES described above, and the written description of specific structures and functions below, are not presented to limit the scope of the inventions disclosed or the scope of the appended claims. Rather, the Figures and Detailed Description are provided to teach a person skilled in this art to make and use the inventions for which patent protection is sought.

A person of skill in this art who has benefit of this disclosure will understand that the inventions are described and taught herein by reference to one or more embodiments, and that these specific embodiments are susceptible to numerous and various modifications and alternative forms without departing from my inventions. For example, and not limitation, a person of skill in this art with this disclosure will understand that FIGURES and/or embodiments that use one or more common structures or elements, such as a structure or an element identified by a common reference number, are linked together for all purposes of supporting and enabling our inventions, and that such individual FIGURES or embodiments are not disparate disclosures. A person of skill in this art with this disclosure will recognize and understand immediately the various other embodiments of my inventions having one or more of the structures, elements, or functions illustrated and/or described in the various linked embodiments. In other words, not all possible embodiments of our inventions are described or illustrated, and one or more of the claims to our inventions may not be directed to a specific, disclosed example or embodiment. Nonetheless, a person of skill in this art within this disclosure will understand that the claims are fully supported by the entirety of this disclosure.

Persons skilled in this art will appreciate that not all features of a commercial embodiment utilizing one or more of the inventions are described or shown for the sake of clarity and understanding. Persons skilled in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art with benefit of this disclosure.

Aspects of the inventions disclosed herein may be embodied as an apparatus, system, method, or computer program product. Accordingly, specific embodiments may take the form of an entirely hardware embodiment, an entirely software embodiment or an embodiment combining software and hardware aspects, such as a “circuit,” “module” or “system.” Furthermore, embodiments of the present inventions may take the form of a computer program product embodied in one or more computer readable storage media having computer readable program code.

Items, components, functions, or structures in this disclosure may be described or labeled as a “module” or “modules.” For example, but not limitation, a module may be configured as a hardware circuit comprising custom VLSI circuits or gate arrays, off-the-shelf semiconductors such as logic chips, transistors, or other discrete components. A module also may be implemented as programmable hardware devices such as field programmable gate arrays, programmable array logic, programmable logic devices, or the like. Modules also may be configured as software for execution by several types of processors. A module of executable code may comprise one or more physical or logical blocks of computer instructions that may be organized as an object, procedure, or function. The executables of a module need not be physically located together but may comprise disparate instructions stored in distinct locations that when joined logically together, comprise the module and achieve the stated purpose or function. A module of executable code may be a single instruction, or many instructions, and may even be distributed over several different code segments, among different programs, and across several memory devices. Similarly, data may be identified and illustrated herein within modules, and may be embodied in any suitable form and organized within any suitable type of data structure. The data may be collected as a single dataset or may be distributed over distinct locations including over different storage devices, and may exist, at least partially, merely as electronic signals on a system or network. Where a module or portions of a module are implemented in software, the software portions may be stored on one or more computer readable storage media.

When implementing one or more of the inventions disclosed herein, any combination of one or more computer readable storage media may be used. A computer readable storage medium may be, for example, but not limitation, an electronic, magnetic, optical, electromagnetic, infrared, or semiconductor system, apparatus, or device, or any suitable combination of the foregoing. More specific, but non-limiting, examples of the computer readable storage medium may include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this disclosure, a computer readable storage medium may be any tangible medium that can contain or store a program for use by or in connection with an instruction execution system, apparatus, or device.

Computer program code for carrying out operations of one or more of the present inventions may be written in any combination of one or more programming languages, including an object-oriented programming language such as Java, Python, C++ or the like and conventional procedural programming languages, such as the “C” programming language or similar programming languages. The program code may execute entirely on the user's computer, partly on the user's computer as a stand-alone software package partly on the user's computer and partly on a remote computer or entirely on the remote computer or server. The remote computer may be connected to the user's computer through any type of network, including a local area network (LAN) or a wide area network (WAN), or the connection may be made to an exterior computer for example, through the Internet using an Internet Service Provider.

Aspects of the present disclosure may be described with reference to schematic flowchart diagrams and/or schematic block diagrams of methods, apparatuses, systems, and computer program products according to embodiments of the disclosure. It will be understood by those of skill in the art that each block of the schematic flowchart diagrams and/or schematic block diagrams, and combinations of blocks in the schematic flowchart diagrams and/or schematic block diagrams, may be implemented by computer program instructions. Such computer program instructions may be provided to a processor of a general-purpose computer, special purpose computer, or other programmable data processing apparatus to create a machine or device, such that the instructions, which execute via the processor of the computer or other programmable data processing apparatus, structurally configured to implement the functions/acts specified in the schematic flowchart diagrams and/or schematic block diagrams block or blocks. These computer program instructions also may be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks. The computer program instructions also may be loaded onto a computer, other programmable data processing apparatus, or other devices to cause a series of operational steps to be performed on the computer, other programmable apparatus or other devices to produce a computer implemented process such that the instructions that execute on the computer or other programmable apparatus provide processes for implementing the functions/acts specified in the flowchart and/or block diagram block or blocks.

The schematic flowchart diagrams and/or schematic block diagrams in the FIGURES illustrate the architecture, functionality, and/or operation of possible apparatuses, systems, methods, and computer program products according to various embodiments of the present inventions. In this regard, each block in the schematic flowchart diagrams and/or schematic block diagrams may represent a module, segment, or portion of code, which comprises one or more executable instructions for implementing the specified logical function(s).

It also should be noted that, in some possible embodiments, the functions noted in the block may occur out of the order noted in the FIGURES. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated FIGURES.

Although various arrow types and line types may be employed in the flowchart and/or block diagrams, they do not limit the scope of the corresponding embodiments. Indeed, some arrows or other connectors may be used to indicate only the logical flow of the depicted embodiment. For example, but not limitation, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, may be implemented by special purpose hardware-based systems that perform the specified functions or acts, or combinations of special purpose hardware and computer instructions.

Reference throughout this disclosure to “one embodiment,” “an embodiment,” or similar language means that a particular feature, structure, or characteristic described in connection with the embodiment is included in at least one of the many possible embodiments of the present inventions. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the scope of what is claimed.

The description of elements in each FIGURE may refer to elements of proceeding FIGURES. Like numbers refer to like elements in all FIGURES, including alternate embodiments of like elements. In some possible embodiments, the functions/actions/structures noted in the FIGURES may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

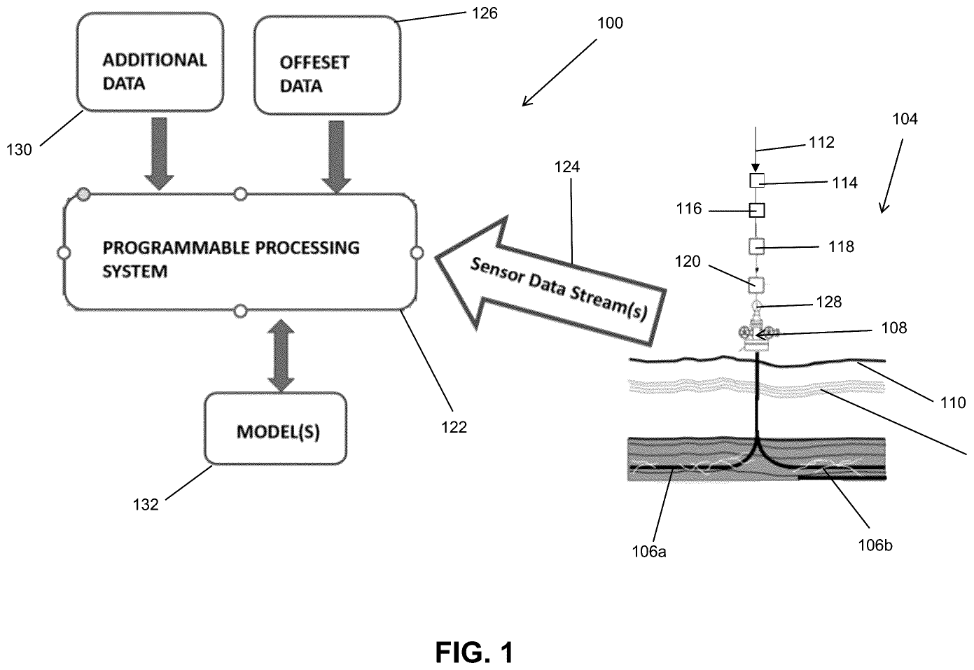

Turning now to a description of one of the many possible embodiments of my inventions, FIG. 1 illustrates a system 100 that may be used to: (i) assess the characteristics of one or more underground geological formations 102; (ii) predict and measure fracture volumes associated with a hydraulic fracturing operation 104; (iii) promote optimum natural microfracture expansion while avoiding screen out; and/or (iv) predict production characteristics. One or more wells 106a, 106b . . . 106n drilled into the formation may be connected to one or more wellheads 108 located at the earth's surface 110 (e.g., land or seabed). During a hydraulic fracturing operation 104, a proppant material 112, such as sand, is supplied to a fracturing fluid blending system 114, which preferably includes one or more pumps 116, a proppant slurry density meter 118 and a proppant slurry flow meter 120.

Data 106 from the hydraulic fracturing operation 104 and/or formations 102 can be offset in time within the same stage or offset in distance from offset wells 106n of known location.

As illustrated in FIG. 1, exemplary system 100 includes a programmable processing system 122 that, in one embodiment, takes the form of a cloud-based computing system. In general, the programmable processing system 122 receives one or more data streams 124 associated with a hydraulic fracturing operation 104 being performed on a given well, wells 106a, 106b . . . 106n or formation 102. It should be appreciated that references herein to a well are intended to encompass references to the formation in which the well is formed and that references to a formation are intended to refer to a well in the formation. As such, all references here in to a well, a formation and/or a well/formation should be understood to also refer to a well, a formation, and/or the well and the formation in which the well is formed. In some cases, different completed intervals in a well penetrate different formations.

The data streams 124 provided to the programmable processing system 122 may take the form of “real-time” data streams, in that each data stream corresponds to a stream of data items collected in substantially real-time. One example of such a data stream is a stream of well-pressure measurements, where each item of data corresponds to or represents the well pressure at a given time. Other examples of data streams include a data stream associated with measurements of the water/slurry flow rate (e.g., in barrels-per-minute); a data stream associated with sand flow or proppant flow (e.g., in pounds per gallon); and/or a data stream associated with sand size, and/or temperature, and/or any other well characteristic to be processed by the programmable processing system 122.

Additionally, or alternatively, offset data 126 may take the form of “historical” data in that it may reflect a stream of data items recorded sometime in the past. The value of historical or offset data 126 may be used to predict future measurements, such as to know whether the rock is of better or worse quality.

It will be appreciated that the distinction between a real-time data stream 124 and a historical data stream 126 is somewhat arbitrary, in that there will likely be at least some time latency between the generation of each item in the data stream and the reception of that data item by the programmable processing system 122.

In general, the data associated with each data stream 124 will have some indication or artifact reflecting a time (absolute or relative or both) when the data item was detected or transduced. Such time indication can take the form of a specific timestamp associated with each data item and indicating when the data item was sampled, a relative time indication, e.g., data indicating a start time, the time interval between measurements, and the measurement number (e.g., 15th sample) associated with each data item, or some other indication of time.

In addition to providing time or timing data, each data stream may provide additional information concerning each, all, or some of the data items in the data stream 124. For example, in certain applications data may be provided concerning different well sites (e.g., 106a, 106b). In such application some or all the data 124 may be provided with an indication of the well associated with the data.

In one exemplary embodiment, the data is sent to the programmable processing apparatus 122 over a single communication link and the programmable processing apparatus 122 will process the received data to associate each data item with a particular well (if data from multiple wells is being provided) and to associate each data item with a particular point in time.

In one embodiment, all the data associated with a given well (e.g., pressure, water flow rate, sand rate, temperature, rock quality) will be time-aligned by the processing system 122 since well characteristics associated with each data category will all be sampled at the same time for a given well. Alternative embodiments are envisioned where the relevant characteristics are sampled at different points in time and then data is interpolated, or otherwise processed, to generate adjusted data sets that are generally time aligned and potentially predictive of future measurements.

In embodiments where the well pressure is provided as an input 124 to the programmable processing system 122, the pressure data may be provided by a quartz gauge 128 having a low signal-to-noise ratios. In such embodiments, it can be beneficial to have the gauge or transducer 128 provide the detected pressure measurements in their “raw” form (e.g., without any smoothing, averaging, or other pre-processing) such that all or substantially all processing of the raw pressure signal measurements is done by the programmable processing system 122.

In another embodiment, the data streams 124 are provided in a time-aligned manner (or are processed through interpolation or otherwise) such that the data within each data stream 124—or each adjusted data stream—reflects the data item at a point that is of known seconds after the corresponding preceding data item. For example, a data stream 124 reflecting well-pressure values, sampled at one second intervals, would have this characteristic. Note that other sampling periods can be used (e.g., data sampled ever ½ second, every 10th of a second, every 1.5 seconds).

In the example of FIG. 1, the programmable processing system 122 receives a first pressure data stream 124a from a first well 106a undergoing hydraulic fracturing 104 and a second data stream 124b from a second offset well 106b located some distance from the first well 106a. In this example, each data stream 124a, 124b is associated with pressure data 128 separated by one second intervals. Ideally, both data streams will be associated with time-aligned pressure data sampled on a one-second interval. The provision of data streams from one or more offset wells is optional.

In addition to receiving one or more data streams the programmable processing system 122 can also receive other inputs in the form of additional data 130 items that can provide information related to the well associated with the well or the geological formation to be analyzed. Such additional information 130 can include, for example, known information concerning the well or formation at issue, such as specific location, general type, depth, length, and other physical characteristics such as organic content, or natural fracturing intensity associated with the well or formation. Such information 130 can also, additionally, or alternatively, include information believed to be accurate or relevant by the user.

In the exemplary embodiment of FIG. 1, the data streams received the programmable processing system 122 are: (i) well head pressure measurements 128 taken on a 1 second interval from a well undergoing hydraulic fracturing 104; (ii) water or slurry flow rate measurements 120 taken on a 1 second interval in time alignment with the pressure measurement 128 for the well 106 undergoing hydraulic fracturing 104; and (iii) sand or proppant 118 concentration measurements (e.g., density meter 118) taken on a 1 second interval in time alignment with the pressure measurement 128 for the well undergoing hydraulic fracturing 104. In the example the programmable processing system 122 will also be provided with data 130 reflecting the size of the sand being used at any given time and an indication of the well associated with the data stream.

As reflected in FIG. 1, the programmable processing system can, in addition to receiving the data streams, also receive one or more offset data streams (or set of offset data streams). In one example, a single offset data stream (designated) will be a stream of data corresponding to pressure measurements of a different location in the same well, or a well that is offset from the well undergoing the hydraulic fracturing operation.

THE MODEL(S): In addition to including apparatus for receiving the data sensor and data inputs described above, the exemplary programmable processing system discussed herein includes one or more models of the well/formation associated with the well/formation to be analyzed by the system. Such models can take many forms and can take the form of a single model (e.g., one that receives a single set of inputs and provides a single set of outputs); a grouping of multiple models (e.g., where several different models each receive the same (or substantially the same inputs) and each produces a separate set of outputs); and/or a combination of multiple models (e.g., where each of several models receives some or all of the inputs provided to other models, each model produces one or more outputs and the outputs are processed by the programmable processing system to produce a set of outputs).

In embodiments where a combination of multiple models is used, the outputs can reflect all or any of a selection of the output from one of the model; a combination (e.g., average, weighted average, neural networks, etc.) of the outputs from some or all of the models, or any other combining process (e.g., discard high/low model output and average the remainder).

As described above, inputs to the programmable processing system can include additional data 130 associated with the well/formation 106, 102 under analysis. Such additional data 130 can be used to tune one or more of the system models 132 to align more closely with the well/formation under analysis. For example, the programmable processing system 122 can be initialized using a base model (or models)132a that is associated with a certain type of well or formation natural fracture system generally, and that base model 132a can then be tuned by the processing system 122 to more closely align with the well/formation under analysis by, for example, using data obtained from wells/formations in the same geographical area and/or having similar geological characteristics.

GENERAL OPERATION: In general operation, the exemplary system of FIG. 1 will receive the provided sensor data 124 and other inputs 126 and/or 130 and apply them to the model 132 (or models 132a, 132b . . . 132n) to generate data and analysis that can be used in real-time to optimize a fracturing operation and/or used to assess the likely productive capability of a well/formation, and for other purposes.

In connection with the above-described analysis, the programmable processing system 122 can monitor the well-pressure 128 and other data provided to the system 100 to detect fracturing events as they occur and to provide information about the various detected fracturing events. For example, in one embodiment, the programmable processing system 122 can use the received sensor data 124 and other inputs 126 and/or 130 to generate information, on a fracture stage-by-stage basis concerning: (a) the potential productivity of the stage undergoing the fracture operation; (b) the extent to which the stage fracturing operation has utilized the potential productivity of stage undergoing a fracturing operation; and

In one exemplary embodiment, a system 100 constructed in accordance with the teachings of this disclosure may use the following input data to estimate the stage hydraulic attributes discussed above: (a) the slurry rate 120; (b) the proppant concentration 118; and (c) the treating pressure 128. These inputs may be generated using sensors that detect the identified input characteristics on a periodic basis (e.g., every second or ½ second) and provide data reflected the detected input data in a time-stamped manner.

Using the input data discussed above, an embodiment of the present inventions may be used to provide information concerning the potential productivity of stage undergoing a fracture operation by processing the received data using data windows, where each data window consists of a series of time-aligned data inputs (e.g., inputs for slurry rate, proppant concentration, and treating pressure) over a specific interval of time). While the duration of the data windows used for implementation of the disclosed system may vary from implantation to implementations, for most implementations, the time duration of the data windows for a given implantation will be the same. As such, one system 100 constructed in accordance with the teachings of this disclosure may use data windows all having a duration of 8 seconds, while another implementation of the present inventions may use data windings having a time duration of 24 seconds.

In many embodiments it will be beneficial to utilize data windows that overlap with each other. Thus, for example, in a system using data windows having an 8 second duration, a first data window could cover the interval from 0-8 seconds from a given time, a second data window could cover the interval from 4-12, and a third from 8-16 and so on. As an alternate example, when 24 second data windows are used, a first window could cover the interval from 0-24, the second from 6-30, the third from 12-36, and so on.

In many implementations it will be beneficial to utilize the data contained in only a subset of the received data 124, 126, and/or 130 windows for further analysis. Specifically, the present applicant has found that useful information concerning the reservoir portion undergoing fracturing during a stage fracturing operation may be best obtained by considering for further analysis only those widows over which: (1) the treating 128 across all data points of the data window is decreasing and (2) the slurry rate (e.g., data from flow meter 120) is increasing or constant over the data window. In such embodiments, data analysis windows containing data that do not meet both criteria set forth above are simply discarded.

Different approaches may be used to determine whether the data associated with a given data analysis window meets the above criteria. In one simple approach the treating pressure 128 and slurry rate 120 for the for the initial and terminal data points within the data analysis window may be compared. If the terminal treating pressure is less than the initial terminal pressure, then the window can be deemed to have a decreasing pressure. If the terminal slurry rate is the same as or greater than the initial slurry rate, then the slurry rate across the window can be deemed to be increasing.

In other embodiments a more complicated process can be used to determine whether the criteria required for consideration of the data analysis window is met. For example, embodiments are envisioned wherein the second-by-second data points for treating pressure (and separately for slurry rate) over the window are curve fit to a linear curve and the slope of the linear curve is assessed to determine whether the parameter under consideration is decreasing (which would be associated with a negative slope), stable zero or near-zero slope, or increasing (positive slope).

The consideration of data associated only with data windows meeting the two criteria set out above is believed to ensure that the analyzed data accurately reflects the true characteristics of a reservoir that is fracturing.

Once a data analysis window is deemed appropriate for further analysis, the present system will assess, for non-discarded data analysis windows, the amount of proppant injected into the well stage for that data analysis window to generate what is referred to herein as the proppant packing magnitude (or PPM) for that data analysis window.

In one such embodiment, the PPM is determined on a per data analysis window basis by considering, the maximum pressure drop that occurred across the data analysis window (i.e., the difference between the maximum treating pressure detected across the window and the minimum treating pressure detected across the window) and the total amount of proppant reaching the fractures as proppant is injected into the stage undergoing a fracturing operation over the data analysis window under consideration.

The total amount of proppant injected into the stage undergoing a fracturing operation over the data analysis window may be assessed by aggregating, over the entire data analysis window, injected proppant calculated on a second-by-second basis. For example, for each second the amount of injected proppant can be calculated by multiplying the slurry rate (typically in barrels per minute by the proppant concentration (typically in pounds/gallon) by the appropriate conversion constant to generate the amount of injected proppant. As a more specific example, when the slurry rate data is in barrels per minute and the proppant concentration data is in pounds per gallon, the proppant injection rate in pounds per second will be:

$$Slurry\_Rate ( bbl / min ) * 1 / 60 ( min / sec ) * Proppant\_Concentration ( lbs / gal ) * 42 ( gal / bbl ) .$$

Once the present system 100 determines the pressure differential across a given data analysis window and the total amount of proppant injected into the stage over that window, the system 100 can then provide an indication (numerical, visual, or otherwise) reflecting the PPM for that data analysis window where the PPM is determined based both on the overall maximum pressure differential across the data analysis window and the amount of injected proppant for that data analysis window with the amount of injected proppant being directly proportional to the PPM value and pressure differential being inversely proportional to the PPM. For example, for a stage where the data analysis pressure differential is 10 PSI and the total injected proppant is 1000 lbs, the PPM for the stage could be determined to be 1000/10=100 in². For an alternate stage, with a pressure differential of 15 PSI and a total injected proppant of 750 lbs, the PPM cold be determined to be 750/15=50 in².

As will be appreciated, using the process described above, a system 100 constructed in accordance with the teachings of the present disclosure can generate PPM values for all non-discarded data analysis windows in real time, as the data for each non-discarded data window is obtained. This real time PPM data can be used to provide an indication of characteristics of the reservoir portion undergoing fracturing over the non-discarded data analysis window. In general, the higher the PPM value over a given data analysis window, the more potentially productive fractures are predicted to be generated within the reservoir over that period of time.

In some embodiments the generated PPM information described above can be beneficially used to provide insights into, and promote the effectiveness and the efficiency of, subsequent stage fracking operations for a given well. This can be done as follows:

First, after one or more stage fracturing operations are completed the stage (or stages) can be subjected to a leak-off process and a leak-off analysis where conventional leak-off processes and analytical techniques can be used to provide an assessed prediction of the lifetime overall production for the stage (or stages) subject to the leak-off analysis. Such processes can involve using individual fracture stage post-fracture falloffs (sometimes referred to as leak-offs) analysis. To conduct such an analysis the pressure 128 within the stage after the completion of a fracturing operation 104 can be monitored over a defined period (typically no less than 10 or 15 minutes and sometimes up to 60 minutes or more). Over this leak-off period, the pressure 128 within the stage under analysis will dissipate into the fracture surfaces created during the fracture operation. The rate of pressure diffusion will be a function of the surface area created during the fracture operation and, as such, one can use the measured leak-off pressure data to estimate the total surface area of the fractures created during the fracture operation. The total surface area of such fractures can then be used (alone, or typically) in combination with other data including data related to the permeability, thickness, porosity, system compressibility, anticipated production fluid, etc. of the reservoir) to estimate the lifetime productivity from the stage under analysis.

Once the above leak-off analysis has been completed, the leak-off data associated with a given stage can be analyzed in conjunction with the with the PPM data generated for that stage during the fracture operation using the processes described above. Such analysis can involve consideration of any or all of: (i) the PPM values of all non-discarded data analysis windows associated with the stage's fracturing operation; (ii) the median PPM value for the stage's fracturing operation; and/or (iii) the max/min PPM values for the stage, the average PPM values for the stage; and (iv) other PPM-related values. This process can involve the use of one or more curve-fitting or complex modeling approaches to associate the PPM values determined by the system during the fracturing operation with the detected leak-off data and the predicted productivity determined using such leak-off data. For example, in some embodiments, a generic algorithm with a dimensional reduction algorithm may be used to fit the assessed data to a quadratic or other order equation to relate the non-discarded data analysis window data (including PPM values determined by the system from such data) with the lifetime productivity data determined using the leak-off process discussed above.

While the example described above discusses a process for determining the relationship between the non-discarded data analysis window data (including PPM values determined by the system from such data) with the lifetime productivity data determined using the leak-off for a given stage, in most embodiments of the present disclosure, such a process will be done using data from multiple stages and, ideally, multiple stages from the same well, from a collection of wells in the same geographical area, and/or from a given region of a common reservoir; and/or from a common petroleum play and/or from regions believed to have similar reservoir characteristics. The use of such additional data can provide for a more robust and more widely applicable model between the non-discarded data analysis window data (including PPM values determined by the system from such data) with the lifetime productivity data determined using leak-off. That model is referred to below as the Performance Prediction Model.

Once this step is completed, the Performance Prediction Model can be used to generate—in real time—second-by-second performance prediction data on a data analysis window by data analysis window basis, in actual or near real time, during a fracking operation. Such performance prediction data can then be used to generate a performance prediction curve (PPC) which can be used to help assess the effectiveness and efficiency of given fracking operation, improve the effectiveness and/or efficiency of a given fracking operation; and/or avoid the unnecessary use of resources in a unproductive fracking operation This can be done by substituting the median PPM inputs used to generate the Performance Predictive Model with the real time median PPM values estimated with respect to each non-discarded data analysis window; substituting the total pressure drop used to create the Performance Prediction Model with the incremental non-discarded data analysis window by non-discarded data analysis window pressure drop; and substituting the total injected proppant volume used to create the Performance Prediction Model with the incremental injected proppant volume as determined on a non-discarded data analysis window by non-discarded data analysis window basis using the approach discussed above.

Performing the substitutions permits the generation of a Performance Prediction Curve that will reflect, for each second, a predicted productivity performance for the stage undergoing the fracturing operation at that point, in real-time.

It has been found that the Performance Prediction Curve can be used to assess and control the fracturing operation to optimize effective fracturing, promote efficient fracturing, and avoid the unnecessary usage of resources. For example, It has been determined that once the predicted value from the Predicted Performance Model has reached a peak value and begins to decrease, further introduction of slurry into to the stage undergoing fracturing is counterproductive. As such, one can monitor Performance Prediction Curve and terminate slurry provision to the stage undergoing a fracturing operation (and terminate the fracturing operation) when the Performance Prediction Curve begins to decrease. This will both optimize the effectiveness of the fracturing operation and avoid the waste of proppant.

As another example, monitoring of the Performance Predictive Curve can show that the predicted production remains low and unchanging during a given fracking operation. Such a condition can indicate that the stage is likely to be nonproductive and that resources should not be used on additional fracking.

In connection with the use of the Performance Prediction Model, it should be noted that it can be beneficially used to processes historical fracture operation data to assess whether a given well is a good candidate for a re-fracing operation. For example, if an assessment of historical data shows that the Performance Prediction Curve for a given well was increasing at the time a prior fracing operation was 10 terminated, it is likely a good candidate for a refracturing operation. If, however, on the other hand the Performance Prediction Curve had reached a peak and was decreasing at the time of termination, the well may not be a good re-fracking candidate.

Further using the described system provides, among other benefits:
1. Each stage hydraulic fracture attributes like Af, xf etc can be estimated from Slurry rate, proppant concentration, and treating pressures. From the estimated fracture attributes, we can estimate the rates from each individual stages using the following equations:

$$q\_stage = f ( xf , η , t , ReservoirConcentration , Treating Pressure ) , \\ where xf ( or , Af ) = f ( slurry rate , proppant concentration , treating pressure ) .$$

2. One can approximate the productivity of the stage during the hydraulic fracturing operations using one of the equations set out above;
3. Geologic constraints on ‘how-much’ proppant can be effectively injected can be estimated and, depending on the geological changes, such attributes can vary;
4. The productivity of a stage can be maximized by altering the proppant concentration during fracturing operations.
5. The resources like—pump-time, proppants and slurry can be optimized for each stage;
6. Stage pump-time (hence, stage time) can be reduced without compromising on the productivity of a stage; and/or
7. Each stage can be planned to maximize productivity with minimum resources spent-pump time, proppant amount and slurry volume.

Other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

What is claimed:

1. A system for predicting fracture, reservoir, and production characteristics from hydraulic fracturing data generated during a fracturing operation of a well, the system comprising:
a proppant slurry density meter configured to provide a slurry density signal, the slurry density signal comprising a series of slurry density data points, each data point corresponding to the density of proppant slurry provided to the well during the fracturing operation sensed at a different time;
a proppant slurry flow meter configured to provide a slurry flow signal, the slurry flow signal comprising a series of slurry flow data points, each data point corresponding to the flow of proppant slurry provided to the well during the fracturing operation sensed at a different time;
a pressure sensor configured to provide a treating pressure signal, the treating pressure signal comprising a series of treating pressure data points, each data point corresponding to a pressure in the he well during the fracturing operation sensed at a different time;
a programmable processing system configured to receive the slurry density signal, the slurry flow signal, and the pressure signal, the programmable processing signal being configured to:
curve fit data points for treating pressure and slurry rate to a linear curve over a plurality of data windows, each data window corresponding to a predetermined period of time;
determine the slope of the linear curve for each of the treating pressure and the slurry rate over each data window;
identify those widows over which: (1) the treating pressure across the data window is decreasing and (2) the slurry rate across the data window is increasing or constant; and
estimate the magnitude of proppant injected into the well for each data window over which the treating pressure is decreasing and the slurry rate is increasing or constant.

2. The system of claim 1, wherein the programmable processing system is a cloud based system.

3. The system of claim 1, wherein the time indication is a timestamp.
